(19) United States
(12) Patent Application Publication
(10) Pub. No.: US 2011/0196787 A1
(43) Pub. Date: Aug. 11, 2011

(54) System And Method Of Transferring Money To An Electronic Wallet

(75) Inventors: Liore Z. Alroy, Passaic, NJ (US); Pierre Beaufils, Brooklyn, NY (US)

(73) Assignee: IDT CORPORATION, Newark, NJ (US)

(21) Appl. No.: 12/702,466

(22) Filed: Feb. 9, 2010

(51) Int. Cl. G06Q 40/00

(52) U.S. Cl. 705/41; 705/44

(57) ABSTRACT

A method of transferring value to an electronic wallet includes obtaining a first telephone number from a user, the first telephone number being associated with a mobile telephone of the user; obtaining a PIN from the user, the PIN being associated with a prepaid money transfer card, the prepaid money transfer card having a value associated therewith; obtaining a second telephone number from the user, the second telephone number being associated with a mobile telephone of an intended recipient of at least some of the value associated with the prepaid money transfer card; and transferring the at least some of the value associated with the prepaid money transfer card with an electronic wallet associated with the second telephone number.

### FIELD OF INVENTION

The present invention relates to transferring value to an electronic wallet. More specifically the invention relates to a system and method for transferring money to an electronic wallet associated with a mobile telephone number.

### DISCUSSION AND BACKGROUND

Traditional money remittance providers' fees structure, capture network and disbursement networks prohibit sending smaller amounts and prohibit sending money frequently. For example, U.S. banks typically charge a fee on the order of $45 for domestic interbank transfers and $35 for international interbank transfers, and such transfers require that both the sender and the recipient have bank accounts at participating institutions. A domestic transfer in the United States of $10 using Western Union cost $12 (120%).

It is desirable to provide a way to send money from one party to another without incurring overhead associated with conventional approaches. It is also desirable to provide a way for a user to pay for another users phone services.

### BRIEF DESCRIPTION OF THE DRAWINGS

The following description, given with respect to the attached drawings, may be better understood with reference to the non-limiting examples of the drawings, wherein:

FIG. 1 is an overview of the system for transferring money according to the present invention.

FIG. 2 is a flowchart showing operation of a method of transferring money to an electronic wallet.

### DESCRIPTION OF THE PRESENTLY PREFERRED EXEMPLARY EMBODIMENTS

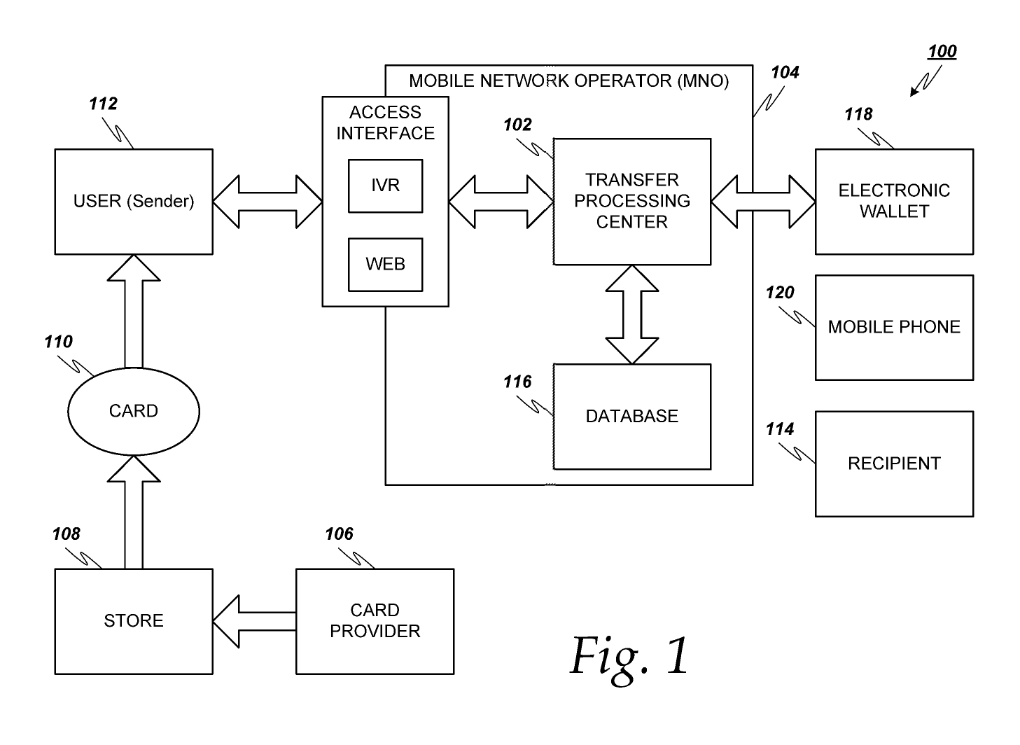

Turning to FIG. 1, a system 100 for transferring money includes a transfer processing center 102 associated with a mobile network operator (MNO) 104. The transfer processing center 102 may be part of a call center associated with the MNO. Calling card providers 106 sell telephone calling cards (and calling card value) to users, typically via stores. As is well known, a calling card provider's calling card 110 may be branded or co-branded with the MNO 104 or some other entity (not shown). The calling card 110 has a monetary value associated therewith, and can be used to make telephone calls using a mobile phone device (not shown).

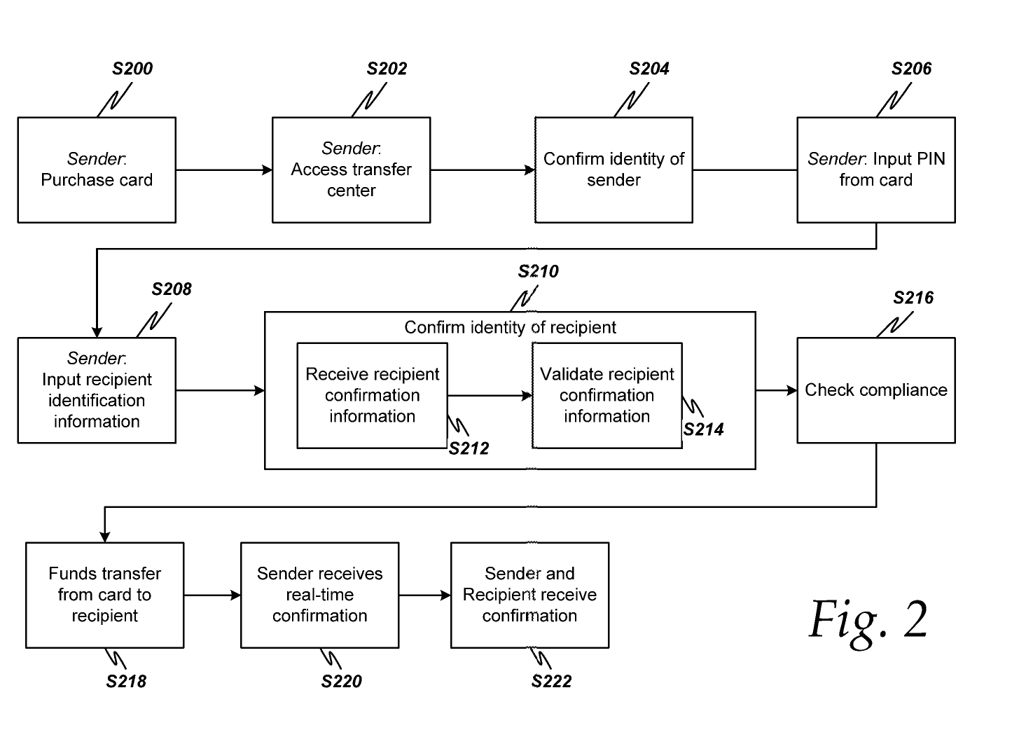

With reference now to FIG. 1 and the flowchart in FIG. 2, the user 112 purchases (at step S200) a calling card 110 (issued by calling card provider 106) from a store 108. The user 112 is also referred to as the “Sender” in this description, although this term is for descriptive purposes only, and is not intended to limit the scope of the invention in any way. The term “purchase” here generally refers to associating value with a card, and a user may obtain a new card or may load value onto a rechargeable card at the store 108. Those of skill in the art will realize, upon reading this description, that the store may be any kind of store including a physical store or an electronic store. Those of skill in the art will realize that in purchasing the card, the user exchanges value (e.g. with cash or a credit card) for that value.

Having purchased the card 100, the user/sender 112 accesses the transfer processing center 102 of the MNO 104 associated with that card (at S202). This access may be in any known manner, e.g., via an Interactive Voice Response (IVR) system or a web-based system. For example, the user/sender 112 may dial a toll-free (“800”) number to access the IVR system or may access the system via a web page.

The transfer processing center 102 confirms the identity of the user/sender 112 (at S204). Preferably a user's phone number is used for identification by the transfer processing center 102, and so a user/sender 112 inputs his phone number to identify himself to the system. The sender's phone number also provides a way to contact the user in case of any problems with the transaction and to provide confirmation of the transaction.

The card 110 preferably has a unique number (PIN) associated therewith. Preferably the PIN is covered by a scratch-off surface, as is well known in the art. Having obtained the card (or value for a re-loaded card), the user inputs the card's PIN to the transfer processing center 102 (at S206). The sender also provides the transfer processing center 102 with identification of the intended recipient 114 of the card's value (at S208). Preferably the user 112 enters the phone number of the intended recipient 114 as a way to identify the recipient to the transfer processing center 102.

The intended recipient 114 preferably has a relationship with the MNO 104, and the identity of the intended recipient (e.g., the phone number) is associated (e.g., in a database 116) with the intended recipient's electronic wallet 118. If the intended recipient 114 does not already have a relationship with the MNO 104, then such a relationship should be established by the recipient in order to complete the transfer.

The transfer processing center 102 then confirms the identity of the intended recipient with the sender 112 (at S210). The transfer processing center 102 may confirm the intended recipient's identity by providing the sender with information about the intended recipient. E.g., in a presently preferred embodiment, the center extracts the intended recipient's name from the database 116. The user/sender 112 receives the recipient confirmation information (at S212) and validates that the recipient information is correct (at S214).

The transfer processing center 102 may then perform additional compliance checks (at S216) to check the transfer from the sender to the recipient complies with regulatory requirements (e.g., know-your-customer) and with the MNO's own rules and requirements. An MNO may impose rules based, e.g., on the number of transfers from or to specific users, on amounts of transfer, on geographical regions associated with the transfer, etc. Those of skill in the art will understand, upon reading this description, that various rules may be imposed by the MNO and/or the card provider, and may be implemented by the transfer processing center 102.

Those of skill in the art will realize, upon reading this description, that various parties in the system may impose transaction fees for transferring a card's value from the sender to the recipient. As such, the value received by the recipient may not be the same as the amount paid by the sender. Those of skill in the art will realize, upon reading this description, that various other factors, including currency exchange rates, regulations, fees, and the like may influence the amount of value actually received by the recipient.

Once any compliance check has been satisfied, the system can then transfer the value associated with the card 110 to the recipient's electronic-wallet 118 (at S218). The sender is given real-time confirmation of the transfer (at S220) via whatever access method was used (e.g., via the IVR or the web). Additionally, both the sender and recipient are notified (at S222) by messages to their respective phones.

If the recipient 114 does not already have a relationship with the MNO 104, the recipient 114 may establish one in order to obtain the value that has been associated with an electronic wallet associated with his phone number.

Thus calling card providers, financial institutions, mobile network operators and other entities can leverage their relationships with their customers and with emerging mobile technologies, to provide an easy and secure way to move funds to (load) a mobile electronic-wallet account, either in-country or cross-border, utilizing distribution channels and processes that are trusted by and familiar to the consumer. This solution allows users without conventional bank accounts to have access to financial services at great convenience and low-cost.

While certain configurations of structures have been illustrated for the purposes of presenting the basic structures of the present invention, one of ordinary skill in the art will appreciate that other variations are possible which would still fall within the scope of the appended claims.

We claim:

1. A method of transferring value to an electronic wallet, the method comprising:
(A) obtaining a first telephone number from a user, the first telephone number being associated with a mobile telephone of the user;
(B) obtaining a PIN from the user, the PIN being associated with a prepaid money transfer card, the prepaid money transfer card having a value associated therewith;
(C) obtaining a second telephone number from the user, the second telephone number being associated with a mobile telephone of an intended recipient of at least some of the value associated with the prepaid money transfer card; and
(D) transferring said at least some of the value associated with the prepaid money transfer card with an electronic wallet associated with the second telephone number.

2. The method of claim 1 further comprising the step of:
confirming the identity of the user prior to the step of transferring.

3. The method of claim 1 further comprising the step of:
confirming the identity of the intended recipient prior to the step of transferring.

4. The method of claim 1 further comprising the step of:
prior to the step of transferring, checking the transferring step complies with regulations.

5. The method of claim 1 further comprising the step of:
prior to the step of transferring, checking the transferring step complies with rules associated with the prepaid money transfer card's issuer.

6. The method of claim 1 further comprising the step of:
(E) confirming the transferring step with the user and the recipient.

7. The method of claim 1 wherein the user is in a first country and the intended recipient is in a second country distinct from the first country, the method further comprising:
converting at least some of the value associated with the prepaid money transfer card from a first currency associated with the first country to a second currency associated with the second country.

8. A method of transferring value to an electronic wallet, the method comprising, by a mobile network operator (MSO):
(A) obtaining a first telephone number from a user, the first telephone number being associated with a mobile telephone of the user;
(B) confirming the identity of the user;
(C) obtaining a PIN from the user, the PIN being associated with a prepaid money transfer card, the prepaid money transfer card having a value associated therewith, the prepaid money transfer card having been provided by a calling card provider;
(D) obtaining a second telephone number from the user, the second telephone number being associated with a mobile telephone of an intended recipient of at least some of the value associated with the prepaid money transfer card; and
(D) transferring said at least some of the value associated with the prepaid money transfer card with an electronic wallet associated with the second telephone number.
